(19) United States
(12) Patent Application Publication
(10) Pub. No.: US 2004/0054528 A1
(43) Pub. Date: Mar. 18, 2004

(54) Noise removing system and noise removing method

(76) Inventors: Tetsuya Hoya, Wako-Shi (JP); Andrzej Cichocki, Wako-Shi (JP); Takahiro Murakami, Nagareyama-Shi (JP); Yoshihisa Ishida, Kawasaki-Shi (JP)

Correspondence Address: BIRCH STEWART KOLASCH & BIRCH, PO BOX 747, FALLS CHURCH, VA, 22040-0747, US

(21) Appl. No.: 10/426,624

(22) Filed: May 1, 2003

(30) Foreign Application Priority Data
May 1, 2002 (JP) 2002-129752
May 1, 2002 (JP) 2002-129820

(51) Int. Cl. G10L 19/14

(52) U.S. Cl. 704/211

(57) ABSTRACT

When M observed signals xᵢ(k) are sequentially inputted into a noise removing part 12 via M channels 11a of an input part 11 in time series, processing is sequentially performed on the observed signals xᵢ(k) by singular value decomposition units 12a of N stages cascaded to one another. Specifically, the singular value deposition unit 12a of each stage separates M input signals into a signal subspace and a noise subspace by a singular value decomposition and extracts M output signals, which are signals over a time region, by orthonormal projection of the M input signals onto the separated signal subspace. Thereby, M signals whose noises have been removed from the M observed signals xᵢ(k) are outputted from the singular value decomposition unit 12a of the N-th stage; after the amplitudes of the respective signals are multiplied with coefficients cᵢ in respective amplitude increasing/decreasing units 14a of an amplitude adjusting part 14, the M signals are outputted via M channels 13a of an output part 13 as M noise-removed signals yᵢ(k) whose noises have been removed.

### BACKGROUND OF THE INVENTION

1. Field of the Invention

The present invention relates to a noise removing system and a noise removing method for removing noises from various observed signals, and in particular to a noise removing system and a noise removing method suitably used for removing a broad-band noise from a narrow-band signal such as a stereophonic speech signal.

2. Description of Related Art

In a field of various signal processings such as a communication processing utilizing a mobile phone or the like, a speech recognition processing, an analytic processing for data transmitted from a radar, a measurement processing for brain waves or electrocardiogram, noise removal is inevitable.

In general, as an approach for reducing a broad-band noise from a narrow-band signal such as a speech signal, the nonlinear spectral subtraction (NSS) (see Publication 1) is used. In this approach, individual spectra corresponding to a speech signal component and a noise signal component are independently estimated on the basis of observed noisy signals within a fixed time and the estimated noise spectrum is subtracted from the observed signals.

However, in such a NSS method, there is a problem that: when a signal whose noise has been removed is converted from a frequency region to a time region, a secondary noise such as some musical instrument tone occurs due to an estimation error of noise spectra, and is introduced while reducing the broad-band noise. At low SNRs, there is also another problem that a portion of the speech signal is removed according to removal of the broad-band noise. Further, in order to obtain an excellent noise reduction performance, there is a problem that it is necessary to adjust many parameters, and it is necessary to perform such an optimal adjustment for each of different environments.

Recently, such an approach has been proposed in a field of biomedical engineering that the singular value decomposition (SVD) (for example, see Publication 2) is applied to a biosignal, i.e., the observed signal, and only a specific element is extracted from the biosignal (see Publications 3 and 4). In these approaches, the observed signals are separated into a signal subspace and a noise subspace by a singular value decomposition, and a plurality of output signals (signals whose noises have been removed), which are signals in a time region, are extracted by orthonormal projection (ONP) of the observed signals onto the separated signal subspace. Incidentally, such a singular value decomposition is applied not only to noise removal from the biosignal but also to noise removal from the speech signal (see Publications 5 to 10).

Further, as an approach using such a singular value decomposition, an approach, where a Wiener filtering is implemented to extract an evoked potential of a brain before application of the singular value decomposition, has been proposed (Publication 11).

In the conventional approaches using the singular value decomposition, however, there is not any consideration for a case that noises are removed from a plurality of observed signals having correlation among them, such as a stereophonic speech signal. Therefore, in such a case, there is a problem that noises cannot be removed from a plurality of input observed signals sufficiently.

Moreover, regarding the approach where Wiener filtering is implemented before application of the singular value decomposition, there is a problem that it is not effective to the observed signal which changes rapidly over time, such as a speech signal, due to the property of the Wiener filter.

### SUMMARY OF THE INVENTION

In view of these circumstances, the present invention has been made, and an object thereof is to provide a noise removing system and a noise removing method which can effectively remove a broad-band noise from a narrow-band signal, such as a stereophonic speech signal or the like.

The present invention provides, as a first aspect, a noise removing system that comprises: an input part including a plurality of channels for inputting a plurality of observed signals; a noise removing part that removes noises from the plurality of observed signals inputted via the plurality of channels of the input part; and an output part including a plurality of channels for outputting a plurality of noise-removed signals whose noises have been removed by the noise removing part, wherein the noise removing part includes singular value decomposition units of plural stages which are cascaded to one another for processing the plurality of observed signals inputted via the plurality of channels of the input part; and the singular value decomposition unit of each stage separates a plurality of input signals corresponding to the respective channels into a signal subspace and a noise subspace by a singular value decomposition, extracts a plurality of output signals, which are signals over a time region, by conducting orthonormal projection of the plurality of input signals onto the separated signal subspace.

Incidentally, in the aforementioned first aspect, it is preferable that the noise removing part further includes a delay element or an advancer that shifts from each other at least two output signals, which belong to different channels of the plurality of output signals outputted from the singular value decomposition unit of each stage, by a predetermined number of samples. Further, it is preferable that an amplitude adjusting part that increases or decreases amplitudes of the plurality of noise-removed signals outputted from the output part is provided.

The present invention provides, as a second aspect, a noise removing method that comprises: a step of inputting a plurality of observed signals; a noise removing step of removing noises from the plurality of observed signals; and a step of outputting a plurality of noise-removed signals whose noises have been removed, wherein, in the noise removing step, the noises are removed from the plurality of observed signals by applying a singular value decomposition to the plurality of observed signals plural times; and the singular value decomposition of each time separates a plurality of input signals corresponding to the plurality of observed signals into a signal subspace and a noise subspace by a singular value decomposition, and extracts a plurality of output signals, which are signals over a time region, by conducting orthonormal projection of the plurality of input signals onto the separated signal subspace.

The present invention provides, as a third aspect, a noise removing system that comprises: an input part including a plurality of channels for inputting a plurality of observed signals; a signal pre-processing part that performs a signal pre-processing so as to remove noises from the plurality of observed signals inputted via the plurality of channels of the input part; an adaptive signal enhancer that performs an adaptive filtering processing so as to enhance a plurality of signals outputted from the signal pre-processing part; and an output part including a plurality of channels for outputting a plurality of signals outputted from the adaptive signal enhancer.

Incidentally, in the aforementioned third aspect, it is preferable that the signal pre-processing part includes a singular value decomposition unit that separates each of the observed signals inputted via the plurality of channels of the input part into a signal subspace and a noise subspace by a singular value deposition, and extracts a plurality of output signals, which are signals over a time region, by conducting orthonormal projection of the plurality of observed signals onto the separated signal subspace. Further, the signal pre-processing section may include singular value decomposition units of plural stages which are cascaded to one another for processing the plurality of observed signals inputted via the plurality of channels of the input part. In this case, the singular value decomposition unit of each stage separates a plurality of input signals respectively corresponding to the respective channels into a signal subspace and a noise subspace by a singular value decomposition, and extracts a plurality of output signals, which are signals over a time region, by conducting orthonormal projection of the plurality of input signals onto the separated signal subspace. Here, it is preferable that the signal pre-processing part further includes a delay element or an advancer that shifts from each other at least two output signals, which belong to different channels of the plurality of output signals outputted from the singular value decomposition unit of each stage, by a predetermined number of samples. Further, it is preferable that the signal pre-processing part further includes an amplitude adjusting part that increases or decreases amplitudes of the plurality of output signals outputted from the singular value decomposition unit of a final stage among the singular value decomposition units of the plural stages.

Further, in the aforementioned third aspect, it is preferable that the adaptive signal enhancer include an adaptive filter that performs an adaptive filtering processing on a plurality of signals outputted from the signal pre-processing part. Moreover, it is preferable that the adaptive signal enhancer further includes a delay element that delays the plurality of signals, which are outputted from the signal pre-processing part and inputted into the adaptive filter, by a predetermined number of samples.

Furthermore, in the aforementioned third aspect, it is preferable that the adaptive signal enhancer is connected in series to or in parallel to the signal pre-processing section.

The present invention provides, as a fourth aspect, a noise removing method that comprises: a step of inputting a plurality of observed signals; a signal pre-processing step of performing a signal pre-processing so as to remove noises from the plurality of observed signals; a step of performing an adaptive filtering processing so as to enhance a plurality of signals which have been subjected to the signal pre-processing; and a step of outputting a plurality of signals which have been subjected to the adaptive filtering processing.

Incidentally, in the aforementioned fourth aspect, it is preferable that, in the signal pre-processing step, a plurality of output signals, which are signals over a time region, are extracted by separating the respective observed signals into a signal subspace and a noise subspace by a singular value decomposition, and orthonormally projecting the plurality of observed signals onto the separated signal subspace. Further, in the signal pre-processing step, noises can be removed from the plurality of observed signals by applying singular value decomposition to the plurality of observed signals plural times. In this case, the singular value decomposition of each time extracts a plurality of output signals, which are signals over a time region, by separating a plurality of input signals corresponding to the plurality of observed signals into a signal subspace and a noise subspace by a singular value decomposition, and orthonormally projecting the plurality of input signals onto the separated signal subspace.

According to the first and second aspects of the present invention, since the singular value decomposition is applied to a plurality of observed signals plural times by singular value decomposition units of plural stages cascaded to one another or the like, even when noises are removed from a plurality of observed signals correlated with one another, such as stereophonic speech signals, only the noises can effectively be removed while maintaining waveforms of inputted observed signals in an excellent state. Further, since singular value decomposition is applied to a plurality of observed signals plural times by the singular value decomposition units of the plural stages cascaded to one another or the like, the number of times of the singular value decomposition applied to the plurality of observed signals can be set to arbitrary times. Even when the number of sensors or the like is small and the number of observed signals is small, a noise reduction performance can easily be improved by increasing the stage number of singular value decomposition units. Furthermore, since the singular value decomposition is used as a noise removing approach applied to a plurality of observed signals, even if the position or the number of noise sources have not been known in advance, separation into signal components and noise components can easily be performed, so that noises can easily be removed from input observed signals.

According to the third and fourth aspects of the present invention, since, after the signal pre-processing has been performed so as to mainly remove noises from a plurality of observed signals by the signal pre-processing part, an adaptive filtering processing is performed so as to enhance a plurality of signals outputted from the signal pre-processing part by the adaptive signal enhancer, even when noises are removed from a plurality of observed signals correlated with one another, such as stereophonic speech signals, only the noises can effectively be removed while maintaining the waveforms of inputted observed signals in an excellent state.

### BRIEF DESCRIPTION OF THE DRAWINGS

FIG. 1 is a block diagram showing a first embodiment of a noise removing system according to the present invention;

FIGS. 2A and 2B are diagrams for explaining outline of a singular value decomposition used in the noise removing system according to the present invention;

FIG. 3 is a block diagram showing a modified embodiment of the noise removing system according to the first embodiment of the present invention;

FIG. 4 is a block diagram showing a second embodiment of a noise removing system according to the present invention;

FIG. 5 is a block diagram showing details of a signal pre-processing part of the noise removing system shown in FIG. 4;

FIG. 6 is a block diagram showing a modified embodiment of the signal pre-processing part shown in FIG. 5;

FIG. 7 is a block diagram showing a modified embodiment of the noise removing system of the second embodiment of the present invention;

FIGS. 8A to 8E are diagrams showing experimental results obtained by using the noise removing system according to the first embodiment of the present invention;

FIGS. 9A and 9B are graphs showing measured results of a gain and a cepstral distance in case that the stage number of singular value decomposition units has been changed in the noise removing system according to the first embodiment of the present invention; and

FIGS. 10A to 10F are diagrams showing experimental results obtained by using the noise removing system according to the second embodiment of the present invention.

### DESCRIPTION OF THE PREFERRED EMBODIMENTS

Embodiments of the present invention will be explained below with reference to the drawings.

First Embodiment

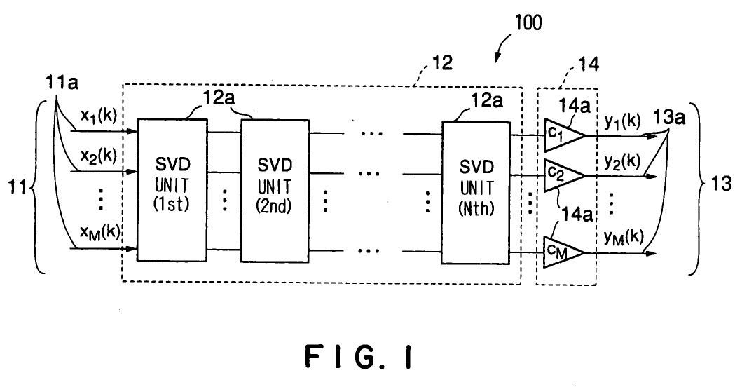

First, a configuration of a first embodiment of a noise removing system according to the present invention will be explained with reference to FIG. 1.

As shown in FIG. 1, a noise removing system 100 according to a first embodiment of the present invention is provided with: an input part 11 having M channels 11a for inputting M observed signals xᵢ(k) (i=1, 2, . . . , M; k is a discrete time) detected by sensors or the like; a noise removing part 12 which removes noises from the M observed signals xᵢ(k) inputted via the M channels 11a of the input part 11; and an output part 13 having M channels 13a for outputting M noise-removed signals yᵢ(k) (i=1, 2, . . . , M; k is a discrete time) whose noises have been removed by the noise removing part 12.

Here, an amplitude adjusting part 14 for increasing/decreasing amplitudes of the M noise-removed signals yᵢ(k) outputted from the output part 13 is provided between the noise removing part 12 and the output part 13. Incidentally, the amplitude adjusting part 14 is provided with M amplitude increasing/decreasing units 14a so as to correspond to the respective channels 13a of the output part 13. Here, symbols cᵢ (i=1, 2, . . . , M) attached to respective amplitude increasing/decreasing units 14a represent coefficients respectively multiplied to M signals outputted from the noise removing part 12, and the values of the coefficients are properly adjusted according to an object. Specifically, for example, in such a case that an adaptive signal enhancer or the like is further connected at a downstream stage of the output part 13, the values of the coefficients cᵢ are adjusted such that enhancement of a specific signal or the like is performed in an excellent manner.

Further, the noise removing part 12 is one for processing M observed signals xᵢ(k) inputted via the M channels 11a of the input part 11, and it has singular value decomposition units (SVD units) 12a of N stages cascaded to one another. Incidentally, the singular value decomposition unit 12a of each stage separates M input signals corresponding to respective ones of the M channels 11a into a signal subspace and a noise subspace by the singular value decomposition, and extracts M output signals, which are signals in a time region, by orthonormally projecting the M input signals onto the separated signal subspace. Incidentally, the fundamental contents of the singular value decomposition performed at the singular value decomposition unit 12a of each stage will be generally similar to an existing one (see Publications 11 and 12, for example).

Details of the singular value decomposition performed at the singular value decomposition unit 12a of each stage will be explained below.

Input signal data is first represented as a matrix X=[x₁, x₂, . . . , x_{M}] in a form of an L×M matrix. Incidentally, the column vector xᵢ (i=1, 2, . . . , M) of the matrix X is xᵢ=[x₁ᵢ, x₂ᵢ, x_{Li}]^{T} (where T represents a transposed vector). Incidentally, an underlined English letter indicates a vector in the specification of the present application.

Such a matrix X for M<L is represented as the following equation (1) by the singular value decomposition.

X=UΣV,^{T} (1)

where the matrices U and V are respectively U=[u₁, u₂, . . . , u_{M}] ε R^{L×M} and V=[v₁, v₂, . . . , v_{M}] ε R^{M×M}, and they are orthogonal matrices which respectively meet U^{T}U=I_{M} and V^{T}V=I_{M}. Further, the matrix Σ is Σ=diag (σ₁, σ₂, . . . , σ_{M}) ε R^{M×M}, where σ₁≧σ₂≧ . . . ≧σ_{M}≧0. Incidentally, row vectors included in the matrices U and V are respectively referred to as a left side singular value vector and a right side singular value vector of X. Also, orthogonal components of the matrix Σ are referred to as singular values, which include information on the number or energy of signals, noise level or the like.

Incidentally, in case that a SN ratio is sufficiently high, the matrix X is decomposed as the following equation (2):

$$X = {[ {U}_{s} {U}_{n} ] [ \begin{matrix}{\sum }_{s} & O \\ O & {\sum }_{n}\end{matrix} ] [ {V}_{s} {V}_{n} ]}^{T} , \qquad ( 2 )$$

where the matrix Σₛ represents the largest singular values associated with s signal sources and matrix Σₙ represents (M−s) singular values associated with the noise. Further, both the matrices Uₛ and Vₛ contain s singular value vectors associated with the signal sources, whereas both the matrices Uₙ and Vₙ contain (M−s) singular value vectors associated with the noise. Incidentally, the subspace spanned by the column vectors of the matrix Uₛ is referred to as a signal subspace, whereas the subspace spanned by the column vectors of the matrix Uₙ is referred to as a noise subspace.

Incidentally, since the signal subspace and the noise subspace are orthogonal to each other theoretically, noise removal can be performed utilizing the principle of least square approximation by conducting orthonormal projection of noisy data which are observed signals onto the signal subspace.

That is, assuming that output signal data after noise removal has been conducted is represented as a matrix Y=[y₁, y₂, . . . , y_{M}] (row vector yᵢ (i=1, 2, . . . , M) is yᵢ=[y₁ᵢ, y₂ᵢ, . . . , Y_{Li}]^{T}), the matrix Y is given by the aforementioned orthonormal projection with the follow equation (3):

Y=U_{S}(U^{T}_{S}U_{S})⁻¹U^{T}_{S}X (3)

Then, the above equation (3) is simply represented such as the following equation (4) due to the property (the orthogonal property) of vectors describing the signal subspace:

Y=UₛU^{T}_{S}X (4)

That is, in the singular value decomposition unit 12a of each stage shown in FIG. 1, using L samples of M input signals inputted from the M channels 11a as one frame, the singular value decomposition is applied to the matrix X including L×M input signals according to the above equation (4).

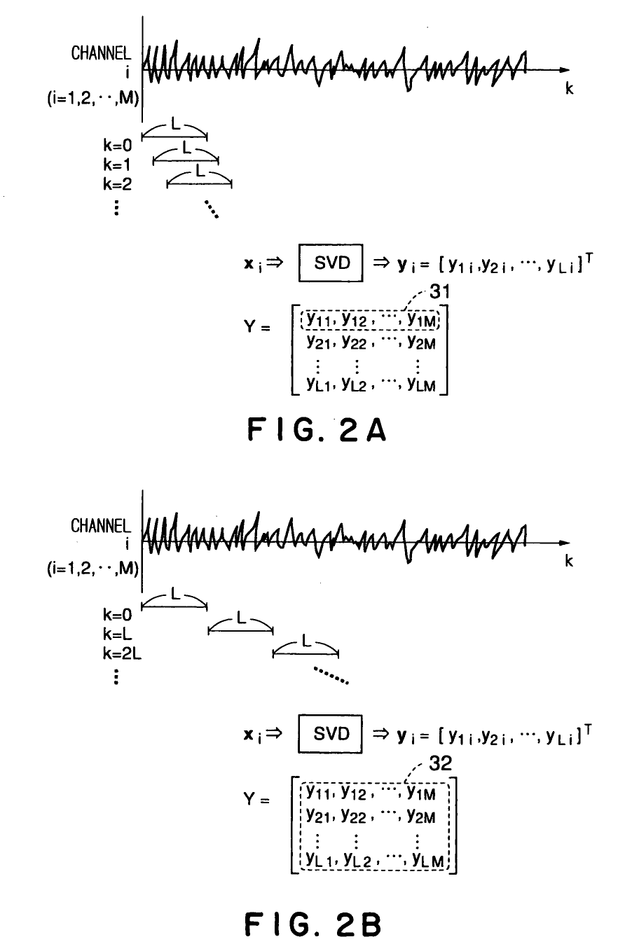

Here, in an existing method using the conventional frame calculating equation (see Publications 11 and 12, for example), as shown in FIG. 2B, a matrix Y corresponding to the matrix X is obtained for each frame corresponding to L samples which do not overlap with one another so that L×M output signals are extracted. As shown in FIG. 2A, however, the matrix Y corresponding to the matrix X may be obtained for each frame corresponding to L samples which overlap with one another so as to be shifted from each other by one sample, instead of the above method.

Incidentally, in the method shown in FIG. 2A, only some elements (refer to reference numeral 31 in FIG. 2A) of the matrix Y as the output result according to the singular value decomposition are used as final output signals, and all the remaining elements are updated for each one increment of discrete time k (each time it gains a time corresponding to one sample). On the contrary, in the method shown in FIG. 2B, all the elements of the matrix Y (refer to reference numeral 32 in FIG. 2B) as the output result according to singular value decomposition are used as final output signals. Incidentally, according to the method shown in FIG. 2A, in the singular value decomposition unit of each stage 12a, update of the matrix Uₛ representing the signal subspace is performed at each point of the discrete time k, so that the singular value decomposition unit can function on the input signal in the same manner as filter. For this reason, the method shown in FIG. 2A can be particularly preferably used in such arrangements that the singular value decomposition units 12a of the plural stages are cascaded.

Next, an operation of the first embodiment of the present invention thus configured will be explained.

In the noise removing system 100 shown in FIG. 1, M observed signals xᵢ(k) detected by sensors or the like are sequentially inputted into the noise removing part 12 via the M channels 11a of the input part 11 in a time series manner.

In the noise removing part 12, first, M observed signals xᵢ(k) inputted via the M channels 11a of the input part 11 are inputted into singular value decomposition unit 12a of the first stage. In the singular value decomposition unit 12a of the first stage, M input signals corresponding to the respective M channels 11a are separated into a signal subspace and a noise subspace according to the aforementioned singular value decomposition; then, M output signals which are signals over a time region are extracted by orthonormal projection of the M input signals onto the separated signal subspace, and the extracted M output signals are sent to a singular value decomposition unit 12a of the next stage (the second stage).

Thereafter, similarly, in singular value decomposition units 12a of the second stage to the N-th stage, processing similar to the processing in the singular value decomposition unit 12a of the first stage are performed utilizing M output signals outputted from the singular value decomposition unit 12a of the preceding stage as input signals.

Thereby, M signals whose noises have been removed from the M observed signals xᵢ(k) are finally outputted from the singular value decomposition unit 12a of the N-th stage.

Here, M signals thus outputted are inputted into the respective amplitude increasing/decreasing devices 14a of the amplitude adjusting part 14 where the amplitude of the respective signals are multiplied by the coefficients cᵢ.

Finally, respective signals whose amplitudes have been increased or decreased by the respective amplitude increasing/decreasing devices 14a of the amplitude adjusting part 14 are outputted via M channels 13a of the output part 13 as M noise-removed signals yᵢ(k) whose noises have been removed.

Thus, according to the first embodiment of the present invention, since the singular value decomposition is applied to a plurality of observed signals xᵢ(k) plural times by singular value decomposition units 12a of plural stages cascaded to one another, even in case that noises are removed from the plurality of observed signals xᵢ(k) correlated with one another, such as stereophonic speech signals, only the noises can effectively be removed while the waveforms of the observed signals xᵢ(k) inputted are maintained in an excellent state.

According to the first embodiment of the present invention, since the singular value decomposition is applied to a plurality of observed signals xᵢ(k) plural times by the singular value decomposition units 12a of plural stages cascaded to one another, the number of times of the singular value decomposition applied to the plurality of observed signals xᵢ(k) can be set to arbitrary times. Even if the number of sensors is small and the number (M) of observed signals xᵢ(k) is small, a noise reduction performance can easily be improved by increasing the stage number (N) of singular value decomposition units 12a.

Furthermore, according to the first embodiment of the present invention, the singular value decomposition is used as the noise removing approach applied to a plurality of observed signals xᵢ(k), even if the positions or numbers of signal sources or noise sources are not known, a signal component and a noise component can easily be separated from each other, and noises can easily be removed from observed signals xᵢ(k) inputted, regardless of the positions or the number of microphones (sensors) for detecting speech signals. That is, the existing speech separation approaches (see Publications 13 to 17) and the like are effective, for example, in case that a plurality of microphones (sensors) are arranged in the vicinity of a signal source respectively. However, there is a problem that these approaches do not work well when all the microphones are provided near a signal source (for example, a speaker) or a microphone is far away from a noise source. Further, there is such a problem that the approaches do not work generally when the number of signal sources is larger than the number of microphones (sensors). However, according to the first embodiment of the present invention, such problems do not occur. Furthermore, even in such an observed signal xᵢ(k) whose amplitude changes rapidly according to a time lapse such as a speech signal, noise can easily be removed from the observed signal xᵢ(k) without using such a mechanism as a voice activity detector or the like.

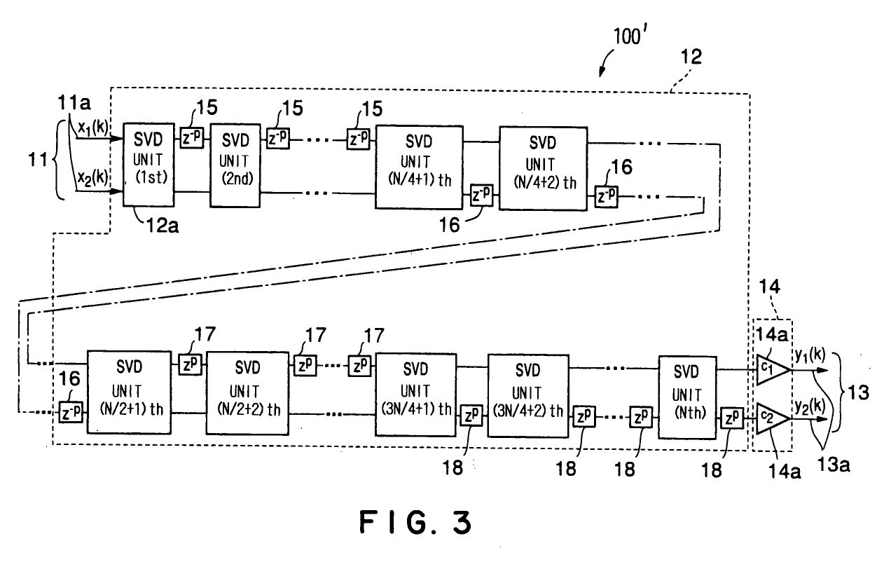

Incidentally, in the aforementioned first embodiment, though the singular value decomposition units 12a of respective stages in the noise removing part 12 are directly connected to one another, such arrangements can be employed that delay elements 15 and 16 or advancers 17 and 18 are inserted between the singular value decomposition units 12a of the respective stages in the noise removing part 12, as shown in FIG. 3.

A noise removing system 100′ shown in FIG. 3 is one where the delay elements 15 and 16 and the advancers 17 and 18 are inserted between the singular value decomposition units 12a of respective stages of the noise removing part 12 in the noise removing system 100 shown in FIG. 1. Incidentally, though the noise removing system 100′ shown in FIG. 3 is used preferably in case that noises are removed from observed noise signals x₁(k) and x₂(k) of two channels which are strongly correlated such as a stereophonic speech signal, it has approximately the same fundamental configuration as the noise removing system 100 shown in FIG. 1. In the noise removing system 100′ shown in FIG. 3, the same portions as those of the noise removing system 100 shown in FIG. 1 are denoted by the same reference numerals, and detailed explanation thereof will be omitted.

As shown in FIG. 3, the noise removing part 12 is provided with delay elements 15 and 16 and advancers 17 and 18 for shifting output signals of the two channels outputted from the singular value decomposition units 12a of the respective stages from each other by p samples. Specifically, as shown in FIG. 3, the delay elements 15 are provided on a first channel (corresponding to the observed signal x₁(k)) at the downstream-sides of the respective singular value decomposition units 12a of the first stage to the (N/4)-th stage, and the delay elements 16 are provided on a second channel (corresponding to the observed signal x₂(k)) at the downstream-sides of the respective singular value decomposition units 12a of the (N/4+1)-th stage to the (N/2)-th stage. The advancers 17 are provided on the first channel at the downstream-sides of the respective singular value decomposition units 12a of the (N/2+1)-th stage to the (3N/4)-th stage, and the advancers 18 are provided on the second channel at the downstream-sides of the respective singular value decomposition units 12a of the (3N/4+1)-th stage to the N-th stage.

Thus, according to the noise removing system 100′ shown in FIG. 3, since a signal of one channel is shifted from a signal of the other channel through the delay elements 15 and 16 or the advancers 17 and 18 by p samples, only signal components which are not correlated with each other can be weaken effectively. That is, regarding observed signals of two channels strongly correlated, such as stereophonic speech signals, it often occurs that speech signal components thereof are strongly correlated with each other in a time axis, whereas noise signal components to be removed, such as white noises, are not correlated with each other. Therefore, the noise removing system 100′ such as shown in FIG. 3 can weaken only the correlation of noise signal components such as white noises whereas maintaining the correlation of the speech signal components to some extent; thus, it can perform noise removal from the observed signals according to the singular value decomposition more effectively. At this time, when a sampling rate/interval is sufficiently high, an estimation error of the signal subspace according to the singular value decomposition is not so problematic, so that the noise-removed signals y₁(k) and Y₂(k) of two channels finally outputted can maintain the waveforms of the observed signals x₁(k) and x₂(k) inputted in an excellent state by setting the sampling rate/interval from such a viewpoint.

Incidentally, in the noise removing system 100′ shown in FIG. 3, the mode that the delay elements 15 and 16 and the advancers 17 and 18 are inserted between the singular value decomposition units 12a of the respective stages can be determined arbitrarily; but it is preferable that the delay elements and advancers of the same number are inserted into the respective channels in view of time consistency between the noise-removed signals y₁(k) and Y₂(k) finally outputted.

Second Embodiment

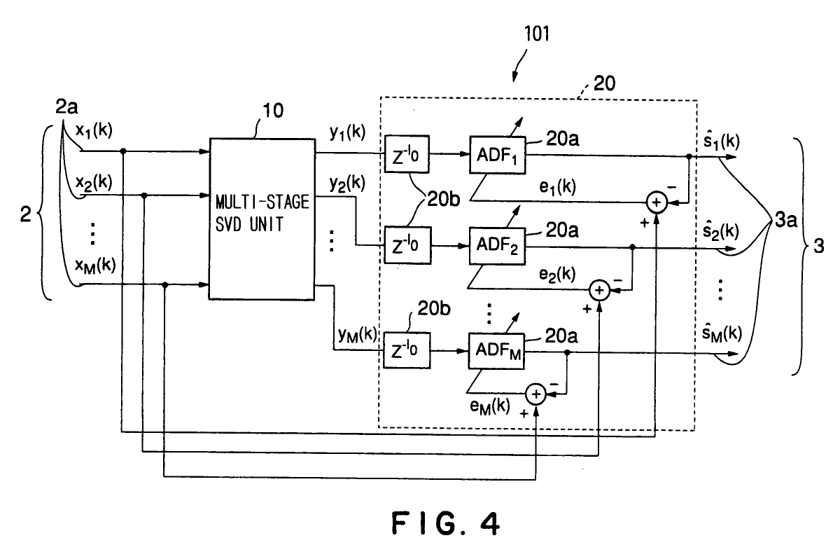

Next, the entire configuration of a second embodiment of a noise removing system according to the present invention will be explained with reference to FIG. 4.

As shown in FIG. 4, a noise removing system 101 according to the second embodiment of the present invention is provided with: an input part 2 having M channels 2a for inputting M observed signals xᵢ(k) (i=1, 2, . . . , M; k is a discrete time) detected by sensors or the like; a signal pre-processing part 10 for performing a signal pre-processing so as to remove noises from the M observed signals xᵢ(k) inputted via the M channels 2a of the input part 2; an adaptive signal enhancer 20 for performing adaptive filtering processing so as to enhance M signals yᵢ(k) (i=1, 2, . . . , M; k is a discrete time) outputted from the signal pre-processing part 10; and an output part 3 having M channels 3a for outputting M signals sᵢ(k) (i=1, 2, . . . , M; k is a discrete time) outputted from the adaptive signal enhancer 20.

(Signal Pre-Processing Part)

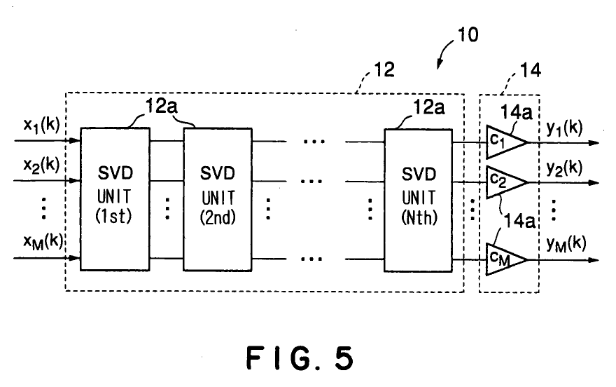

FIG. 5 is a diagram showing a detailed configuration of the signal pre-processing part 10 shown in FIG. 4. As shown in FIG. 5, the signal pre-processing part 10 comprises: a noise removing part 12 for removing noises from M observed signals xᵢ(k) inputted via M channels 2a of the input part 2; and an amplitude adjusting part 14 for increasing or decreasing amplitudes of M signals yᵢ(k) outputted from the noise removing part 12.

Of these parts, the noise removing part 12 is for processing M observed signals xᵢ(k) inputted via M channels 2a of the input part 2 and has singular value decomposition units (SVD units) 12a of N stages cascaded to one another. Incidentally, the singular value decomposition unit 12a of each stage separates M input signals corresponding to the respective M channels 2a into a signal subspace and a noise subspace according to the singular value decomposition, and extracts M output signals, which are signals over a time region, by orthonormally projecting the M input signals onto the separated signal subspace. Incidentally, a fundamental approach of the singular value decomposition performed at the singular value decomposition unit 12a of each stage is similar to an existing one (for example, see Publications 11 and 12) as an outline. Here, since the details of the singular value decomposition performed at the singular value decomposition unit 12a of each stage are similar to those in the aforementioned first embodiment, detailed explanation of the singular value decomposition will be omitted.

Further, the amplitude adjusting part 14 has M amplitude increasing/decreasing units 14a so as to correspond to the respective channels 3a of the output part 3. Incidentally, a symbol cᵢ (i=1, 2, . . . , M) attached to each amplitude increasing/decreasing unit 14a represents a coefficient multiplied to each of the M signals outputted from the noise removing part 12, and the value of the coefficient is adjusted properly such that enhancement of a signal is conducted excellently at the adaptive signal enhancer 20 (refer to FIG. 4) connected at the downstream-side of the amplitude adjusting part 14.

(Adaptive Signal Enhancer)

As shown in FIG. 4, the adaptive signal enhancer 20 is serially connected at the downstream-side of the signal pre-processing part 10.

Here, the adaptive signal enhancer 20 includes: adaptive filters 20a for performing adaptive filtering processing on each signal of M signals yᵢ(k) outputted from the signal pre-processing part 10; and delay elements 20b for delaying the signal yᵢ(k) inputted into the adaptive filter 20a by a predetermined sample number 1₀.

The adaptive filters 20a are for performing adaptive filtering processing on the signals yᵢ(k) delayed by the predetermined sample number 1₀ to output final noise-removed signals sᵢ(k), and a coefficient used in each of the adaptive filters 20a is updated inside of the filter according to a predetermined algorithm (for example, NLMS (normalized LMS) process) on the basis of an error output eᵢ(k) (a difference between an observed signal xᵢ(k) and a noise-removed signal sᵢ(k)). Incidentally, the adaptive filtering processing per se is similar to an existing one (for example, see Publication 20).

Further, the delay elements 20b are for intentionally delaying the signals yᵢ(k) outputted from the signal pre-processing part 10 to be inputted into the adaptive filters 20a by 1₀ (=(L_{f}−1)/2) samples (L_{f} is the length of the adaptive filter). By delaying the signals yᵢ(k) inputted into the adaptive filters 20a by a predetermined sample number 1₀ in this manner, noises are effectively removed from the signals yᵢ(k) by the adaptive filtering processing performed at the adaptive filters 20a; in addition, deviations of amplitude and phase between channels, which are properties of a stereophonic speech signal or the like, can be restored effectively.

Next, an operation of the second embodiment of the present invention thus configured will be explained.

In the noise removing system 101 shown in FIG. 4, M observed signals xᵢ(k) detected by sensors or the like are sequentially inputted into the signal pre-processing part 10 via the M channels 2a of the input part 2 in time series manner.

In the signal pre-processing part 10, signal pre-processing is performed so as to remove noises from M observed signals xᵢ(k).

Specifically, in the signal pre-processing part 10, as shown in FIG. 5, M observed signals xᵢ(k) inputted via M channels 2a of the input section 2 are inputted into the singular value decomposition unit 12a of the first stage. The singular value decomposition unit 12a of the first stage separates M input signals corresponding to the respective M channels 2a into a signal subspace and a noise subspace according to the aforementioned singular value decomposition and extracts M output signals, which are signals over a time region, by orthonormal projection of the M input signals onto separated signal subspace to send the extracted M output signals to a singular value decomposition unit 12a of the next stage (the second stage).

Thereafter, similarly, in the singular value decomposition units 12a of the second to the N-th stages, M output signals outputted from the singular value decomposition unit 12a of the preceding stage are processed as input signals in the same manner as the singular value decomposition unit 12a of the first stage.

Thereby, a plurality of signals whose noises have been removed from M observed signals xᵢ(k) are finally outputted from the singular value decomposition unit 12a of the N-th stage.

Here, the plurality of signals thus outputted are inputted into the respective amplitude increasing/decreasing units 14a of the amplitude adjusting part 14 where the amplitudes of the respective signals are multiplied by the coefficients cᵢ.

Thereafter, the respective signals whose amplitudes have been increased or decreased by the respective amplitude increasing/decreasing units 14a of the amplitude adjusting part 14 are outputted from the signal pre-processing part 10 as M signals yᵢ(k) on which signal pre-processing has been performed and inputted into the adaptive signal enhancer 20, as shown in FIG. 4.

In the adaptive signal enhancer 20, adaptive filtering processing is performed so as to enhance the M signals yᵢ(k) on which the signal pre-processing has been performed.

Specifically, in the adaptive signal enhancer 20, after M signals yᵢ(k) outputted from the signal pre-processing section 10 are each delayed by the predetermined sample number 1₀, each signal yᵢ(k) is inputted into the adaptive filter 20a, and the adaptive filtering processing is performed on the signal yᵢ(k) delayed in the adaptive filter 20a by the predetermined sample number 1₀, thereby outputting the final noise-removed signal sᵢ(k). Incidentally, the coefficient used in the adaptive filter is updated according to a predetermined algorithm (for example, NLMS process) on the basis of the error output eᵢ(k) (a difference between the observed signal xᵢ(k) and the noise-removed signal sᵢ(k)) inside the adaptive filter 20a.

Thus, according to the second embodiment of the present invention, after the signal pre-processing has been performed so as to mainly remove noises from the plurality of observed signals xᵢ(k) by the signal pre-processing section 10, the adaptive filtering processing is performed so as to enhance a plurality of signals yᵢ(k) outputted from the signal pre-processing section 10 by the adaptive signal enhancer 20, so that, even in case that noises are removed from a plurality of observed signals xᵢ(k) which are correlated to each other, such as stereophonic speech signals, only the noises can effectively be removed while maintaining the waveforms of the inputted observed signals xi(k) in an excellent state.

Further, according to the second embodiment of the present invention, since the singular value decomposition is applied to a plurality of observed signals xᵢ(k) plural times by the singular value decomposition units 12a of the plural stages cascaded to one another in the signal pre-processing section 10, even in case that noises are removed from the plurality of observed signals xᵢ(k) which are correlated to one another, such as stereophonic speech signals, only the noises can effectively be removed while maintaining the waveforms thereof in an excellent state. Furthermore, since the singular value decomposition is applied to a plurality of observed signals xᵢ(k) plural times by the singular value decomposition units 12a of the plural stages cascaded to one another, the number of times of the singular value decomposition applied to the plurality of observed signals xᵢ(k) can be set to arbitrary times. Even when the number of sensors or the like is small and the number (M) of observed signals xᵢ(k) is small, a noise reduction performance can easily be improved by increasing the stage number (N) of the singular value decomposition units 12a. Moreover, since the singular value decomposition is used as the noise removing approach applied to a plurality of observed signals xᵢ(k), even if the positions or numbers of signal sources or noise sources are not known in advance, a signal component and a noise component can easily be separated from each other, and noises can easily be removed from observed signals xᵢ(k) inputted, regardless of the positions or the number of microphones (sensors) for detecting speech signals. That is, the existing speech separation approaches (see Publications 13 to 17) and the like are effective, for example, in case that a plurality of microphones (sensors) are arranged in the vicinity of a signal source, respectively. However, there is a problem that these approaches do not work well when all the microphones are provided near a signal source (for example, a speaker) or a microphone is far away from a noise source. Further, there is such a problem that the approaches do not work generally when the number of signal sources is larger than the number of microphones (sensors). However, according to the second embodiment of the present invention, such problems do not occur. Furthermore, even in such an observed signal xᵢ(k) whose amplitude changes rapidly according to a time lapse such as a speech signal, noise can easily be removed from the observed signal xᵢ(k) without using such a mechanism as a voice activity detector or the like.

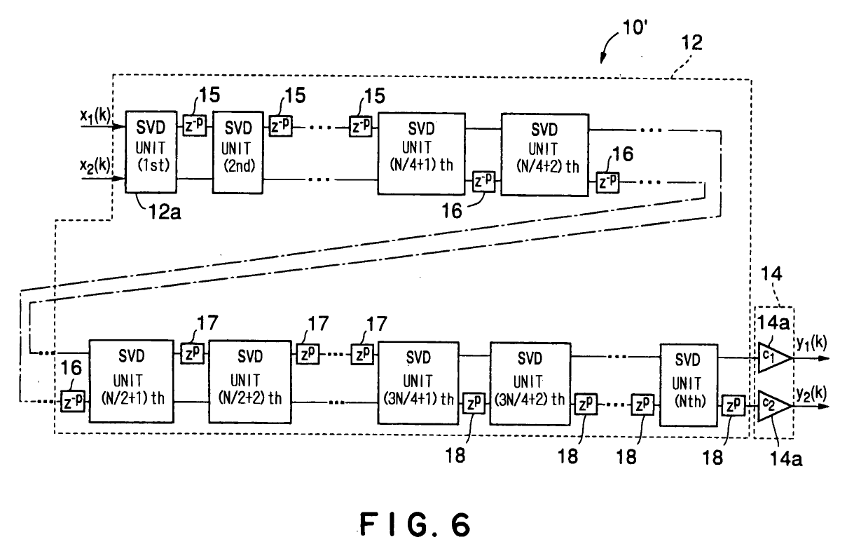

Incidentally, in the aforementioned second embodiment, though the singular value decomposition units 12a of respective stages in the noise removing part 12 of the signal pre-processing part 10 are directly connected to one another, such arrangements can be employed that delay elements 15 and 16 or advancers 17 and 18 are inserted between the singular value decomposition units 12a of the respective stages in the noise removing part 12, as shown in FIG. 6.

A signal pre-processing part 10′ shown in FIG. 6 is one where the delay elements 15 and 16 and the advancers 17 and 18 are inserted between the singular value decomposition units 12a of respective stages of the noise removing part 12 in the signal pre-processing part 10 shown in FIG. 5. Incidentally, though the signal pre-processing section 10′ shown in FIG. 6 is used preferably in case that noises are removed from observed noises xᵢ(k) and x₂(k) of two channels which are strongly correlated, such as stereophonic speech signals, it has approximately the same fundamental configuration as the signal pre-processing section 10 shown in FIG. 5. In the signal pre-processing section 10′ shown in FIG. 6, the same portions as those of the signal pre-processing part 10 shown in FIG. 5 are denoted by the same reference numerals, and detailed explanation thereof will be omitted.

As shown in FIG. 6, the noise removing part 12 is provided with delay elements 15 and 16 and advancers 17 and 18 for shifting signals of the two channel outputted from the singular value decomposition units 12a of the respective stages from each other by p samples. Specifically, as shown in FIG. 6, the delay elements 15 are provided on a first channel (corresponding to the observed signal x₁(k)) at the downstream-sides of the respective singular value decomposition units 12a of the first stage to the (N/4)-th stage, and the delay elements 16 are provided on a second channel (corresponding to the observed signal x₂(k)) at the downstream-sides of the respective singular value decomposition units 12a of the (N/4+1)-th stage to the (N/2)-th stage. The advancers 17 are provided on the first channel at the downstream-sides of the respective singular value decomposition units 12a of the (N/2+1)-th stage to the (3N/4)-th stage, and the advancers 18 are provided on the second channel at the downstream-sides of the respective singular value decomposition units 12a of the (3N/4+1)-th stage to the N-th stage.

Thus, according to the signal pre-processing part 10′ shown in FIG. 6, since a signal of one channel is shifted from a signal of the other channel through the delay elements 15 and 16 or the advancers 17 and 18 by p samples, only signal components which are not correlated with each other can be weaken effectively. That is, regarding observed signals of two channels strongly correlated, such as stereophonic speech signals, it often occurs that speech signal components thereof are strongly correlated with each other in a time axis, whereas noise signal components to be removed, such as white noises, are not correlated with each other. Therefore, the signal pre-processing part 10′ such as shown in FIG. 6 can weaken only the correlation of noise signal components such as white noises whereas maintaining the correlation of the speech signal components to some extent; this, it can perform noise removal from the observed signals according to the singular value decomposition more effectively. At this time, when a sampling rate/interval is sufficiently high, an estimation error of the signal subspace according to the singular value decomposition is not so problematic, so that the noise-removed signals y₁(k) and Y₂(k) of two channels finally outputted can maintain the waveforms of the observed signals x₁(k) and x₂(k) inputted in an excellent state by setting the sampling rate/interval from such a viewpoint.

Incidentally, in the signal pre-processing part 10′ shown in FIG. 6, the made that the delay elements 15 and 16 and the advancers 17 and 18 are inserted between the singular value decomposition units 12a of the respective stages can be determined arbitrarily; but it is preferable that the delay elements and advancers of the same number are inserted into the respective channels in view of time consistency between the signals y₁(k) and Y₂(k) finally outputted.

Further, in the aforementioned second embodiment, as the approach of the signal pre-processing in the signal pre-processing section 10, such an approach that the singular value decomposition is applied to a plurality of observed signals xᵢ(k) plural times by the singular value decomposition units 12a of the plural stages cascaded to one another is used, but, instead of this approach, such an approach that the singular value decomposition is applied to a plurality of observed signals xᵢ(k) by a single singular value decomposition unit can be used, and various approaches such as a non-linear spectral subtraction method (Publication 1), MUSIC process (Publication 21) or the like can be used.

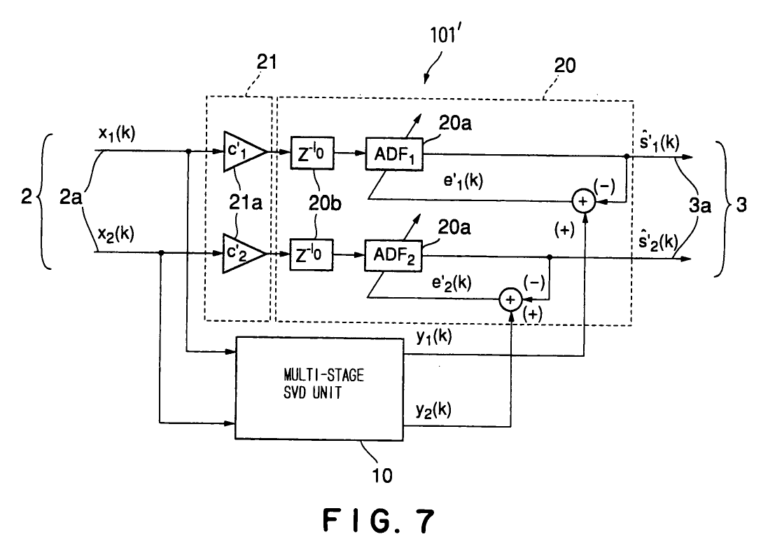

Moreover, in the aforementioned second embodiment, the adaptive signal enhancer 20 is connected to the signal pre-processing section 10 in series, but, instead of the series connection, the adaptive signal enhancer 20 may be connected to the signal pre-processing section 10 in parallel, as the noise removing system 101′ shown in FIG. 7. Incidentally, a fundamental configuration of each portion of the noise removing system 101′ shown in FIG. 7 is approximately the same as that of noise removing system 101 shown in FIG. 4. Further, in case of the noise removing system 101′ shown in FIG. 7, an amplitude adjusting section 21 having a plurality of amplitude increasing/decreasing units 21a for increasing/decreasing the amplitudes of a signal inputted into the adaptive signal enhancer 20 is provided.

### EXAMPLES

### Example 1

Next, a specific example of the aforementioned first embodiment will be explained.

Using such a noise removing system as shown in FIG. 1, experiments for removing noises from stereophonic speech signals of two channels was conducted. Here, three kinds of stereophonic speech signals which were respectively recorded by three speaking persons (two males and one female) (sampled at 48 kHz) in an anechoic chamber were prepared as the stereophonic speech signals, and the following three kinds of noises (noises corresponding to two channels) were added to the three kinds of stereophonic speech signals, respectively:

(1) Noise with no correlation;

(2) Noise given with some cross-correlation by a fixed filter obtained assuming an impulse response of an anechoic chamber from one white noise source; and

(3) Periodic and broad-band noise obtained by modeling engine noise of a motor car.

Experiments for removing the aforementioned nine kinds of stereophonic speech noisy signals were conducted using a noise removing system with such a configuration as shown in FIG. 1. Here, the stage number N of the singular value decomposition units was 4, the length L of an analysis matrix used in the singular value decomposition unit of each stage was 32, and the value of the coefficient cᵢ was 0.1.

As a result, regarding each of the stereophonic speech noisy signals, the noises were sufficiently removed and speech waveforms approximating to the original speech waveforms were obtained.

Incidentally, as a comparison experiment, delay elements and advancers (the sample number p=1 or 6) were inserted between the singular value decomposition units of respective stages, and an experiment for removing noises from the aforementioned nine kinds of stereophonic speech noisy signals was conducted. In respective stereophonic speech noisy signals, also, the cases where the delay elements and the advancers were inserted were improved in noise reduction performance as compared with the cases that they were not inserted.

Further, as a comparison experiment, an experiment for removing noises from the aforementioned nine kinds of stereophonic speech noisy signals using the conventional nonlinear spectral subtraction process (NSS) was conducted. In the respective stereophonic speech noisy signals, their speech waveforms were largely deformed and secondary noises such as a kind of music instrument noise were added.

Taking one stereophonic speech signal of the aforementioned nine kinds of stereophonic speech noisy signals as an example, its experimental results will be explained in detail.

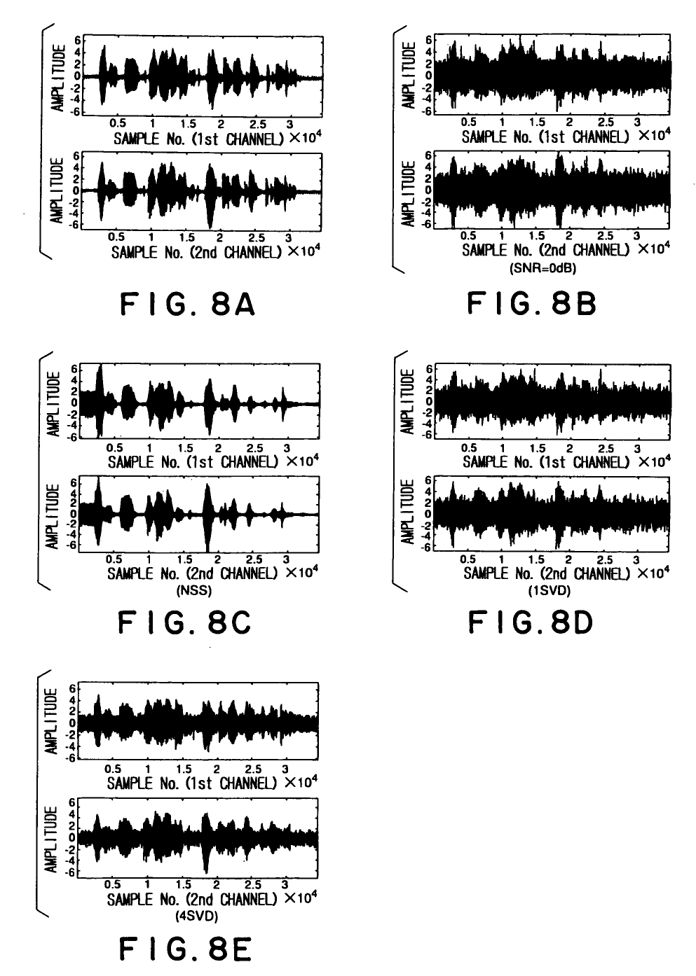

FIG. 8A to FIG. 8E are diagrams of the experimental results using one stereophonic speech signal of the aforementioned nine kinds of stereophonic speech noisy signals (obtained by adding a stereophonic speech signal recorded by one male with a noise having no correlation). Incidentally, FIG. 8A shows a waveform of a stereophonic speech signal before a noise is added thereto; FIG. 8B shows a waveform of a noise added to the stereophonic speech signal; FIG. 8C shows a waveform of a stereophonic speech signal after the noise was removed by the nonlinear spectral subtraction process (NSS); FIG. 8D shows a waveform of a stereophonic speech signal after the noise was removed by the singular value decomposition unit of one stage; and FIG. 8E shows a waveform of a stereophonic speech signal after the noise was removed by the singular value decomposition units of four stages.

As understood from a comparison of FIG. 8D and FIG. 8E, the speech waveform shown in FIG. 8E is more similar to the original speech waveform shown in FIG. 8A than the speech waveform shown in FIG. 8D. The result coincided with an actual result of listening of a noise-removed signal. Incidentally, the speech waveform shown in FIG. 8C appears to be similar to the original speech waveform shown in FIG. 8A as compared with the speech waveform shown in FIG. 8E, but when a signal after noises were removed is actually listened to, the noises were added with such a secondary noise as one kind of music instrument sound.

On the other hand, regarding the same stereophonic speech noisy data as those used in the aforementioned experiments shown in FIG. 8A to FIG. 8E, a segmental gain and a cepstral distance (for example, see Publications 18 and 19) were measured while the stage number of the singular value decomposition units was being changed from 1 to 10.

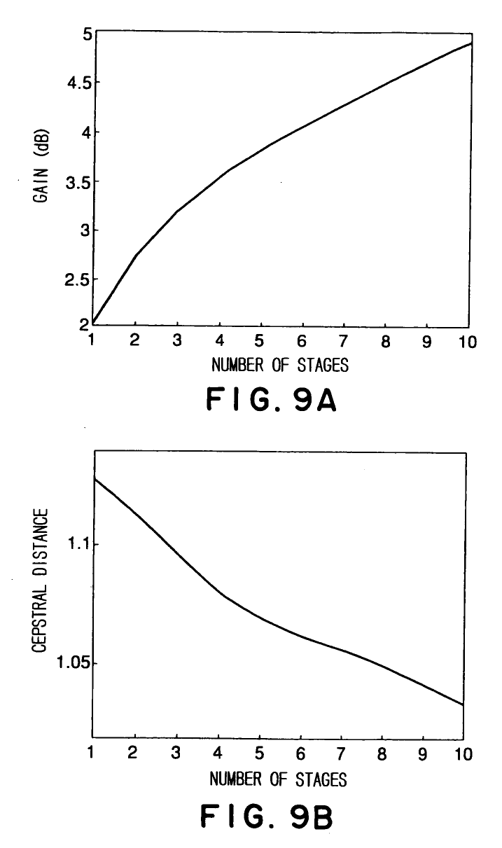

FIG. 9A and FIG. 9B show the measured results of the segmental gain and cepstral distance, respectively. As shown in FIG. 9A and FIG. 9B, it will be understood that the performances of both the segmental gain and the cepstral distance are improved generally linearly by increasing the stage number N of the singular value decomposition units cascaded.

### Example 2

Next, a specific example of the aforementioned second embodiment will be explained.

Experiments for removing noises from stereophonic speech signals of two channels using such a noise removing system as shown in FIG. 4 were conducted. Here, like the aforementioned example 1, three kinds of stereophonic speech signals recorded by three speakers (two males and one female) in an anechoic chamber (sampled at 48 kHz) were prepared as the stereophonic speech signals, and the following three kinds of noises (noises corresponding to two channels) were added to the three kinds of stereophonic speech signals, respectively:

(1) Noise with no correlation;

(2) Noise given with some cross-correlation by a fixed filter obtained assuming an impulse response of an anechoic chamber from one white noise source; and

(3) Periodic and broad-band noise obtained by modeling engine noise of a motor car.

Experiments for removing the aforementioned nine kinds of stereophonic speech noisy signals were conducted using a noise removing system with such a configuration as shown in FIG. 4. Here, regarding the signal pre-processing part, the stage number N of the singular value decomposition units was 4, the length L of an analysis matrix used in the singular value decomposition unit of each stage was 32, and the value of the coefficient cᵢ was 0.1. Further, regarding the adaptive signal enhancer, the length of an adaptive filter is 51, and the NLMS process was used as an algorithm for updating the coefficient of the adaptive filter.

As a result, regarding each of the stereophonic speech noisy signals, noises were sufficiently removed and speech waveforms approximating to the original speech waveforms were obtained.

Incidentally, as a comparison experiment, delay elements and advancers (the sample number p=1 or 6) were inserted between the singular value decomposition units of respective stages, and an experiment for removing noises from the aforementioned nine kinds of stereophonic speech noisy signals was conducted. In respective stereophonic speech noisy signals, also, the cases where the delay elements and the advancers were inserted were improved in noise reduction performance as compared with the cases that they were not inserted.

Further, as a comparison experiment, an experiment for removing noises from the aforementioned nine kinds of stereophonic speech noisy signals using the conventional nonlinear spectral subtraction process (NSS) was conducted. In the respective stereophonic speech signals, their speech waveforms were largely deformed and secondary noises such as a kind of music instrument noise were added.

Taking one stereophonic speech signal of the aforementioned nine kinds of stereophonic speech noisy signals as an example, its experimental results will be explained in detail.

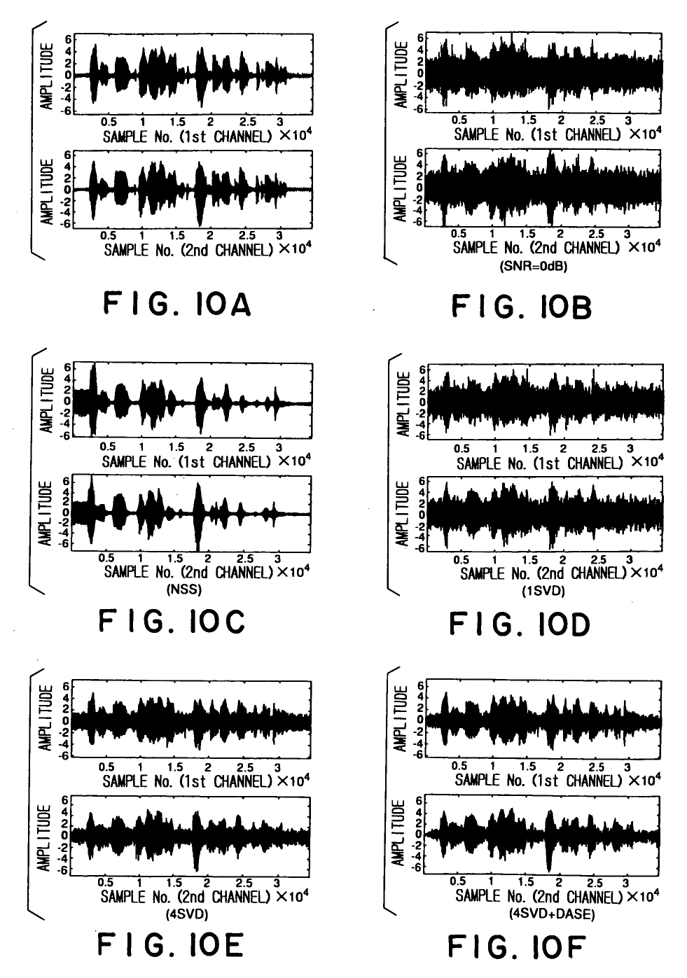

FIG. 10A to FIG. 10F are diagrams of the experimental results using one stereophonic speech signal of the aforementioned nine kinds of stereophonic speech noisy signals (obtained by adding a stereophonic speech signal recorded by one male with a noise having no correlation). Incidentally, FIG. 10A shows a waveform of a stereophonic speech signal before a noise is added thereto; FIG. 10B shows a waveform of a noise added to the stereophonic speech signal; FIG. 10C shows a waveform of a stereophonic speech signal after the noise was removed by the nonlinear spectral subtraction process (NSS); FIG. 10D shows a waveform of a stereophonic speech signal after the noise was removed by only the signal pre-processing part (the singular value decomposition unit of one stage); FIG. 10E shows a waveform of a stereophonic speech signal after the noise was removed by only the signal pre-processing part (the singular value decomposition units of four stages); and FIG. 10F shows a waveform of a stereophonic speech signal after the noise was removed by a combination of the signal pre-processing part (the singular value decomposition units of four stages) and the adaptive signal enhancer.

As understood from a comparison of FIG. 10D, FIG. 10E and FIG. 10F, the speech waveform shown in FIG. 10E is more similar to the original waveform shown in FIG. 10A than the waveform shown in FIG. 10D, and the speech waveform shown in FIG. 10F is more similar to the original waveform shown in FIG. 10A than the speech waveform shown in FIG. 10E. The result coincided with an actual result of listening of a noise-removed signal. Incidentally, in the case shown in FIG. 10E (in the case that only the adaptive signal enhancer was used), the stereophonic images were erased while removing the noise, and the speech was heard as a monophonic speech of two channels. However, in the case shown in FIG. 10F (in the case of combination with the adaptive signal enhancer), removal of the noise was improved at a level of 2 to 3 dB and the stereophonic images were restored. Incidentally, such improvements were also confirmed by experimental results obtained by one objective measurement such as a segmental gain and a cepstral distance (for example, see Publications 18 and 19).

Incidentally, the speech waveform shown in FIG. 10C appears to be similar to the original waveform shown in FIG. 10A as compared with the speech waveforms shown in FIG. 10E and FIG. 10F, but when a signal after noises were removed is actually listened to, the noises were added with such a secondary noise as one kind of music instrument sound.

### PUBLICATIONS

[1] R. Martin, “Spectral subtraction based on minimum statistics,” Proc. EUSIPCO-94, pp. 1182-1185, Edinburgh, 1994.

[2] G. H. Golub and C. F. Van Loan, Matrix Computation, 3rd Ed., The Johns Hopkins Univ. Press, Baltimore and London, 1996.

[3] P. A. Karjalainen, J. P. Kaipio, A. S. Koistinen and M. Vuhkonen, “Subspace regularization method for the single-trial estimation of evoked potentials,” IEEE Trans. Biomed. Eng., Vol. 40, pp. 849-860, July 1999.

[4] T. Kobayashi and S. Kuriki, “Principle component elimination method for the improvement of S/N in evoked neuromagnetic field measurements,” IEEE Trans. Biomed. Eng., Vol. 46, pp. 951-958, August 1999.

[5] F. Asano, S, Hayamizu, T. Yamada, and S. Nakamura, “Speech enhancement based on the subspace method,” IEEE Trans. Speech, Audio Proc., Vol. 8, No. 5, pp. 497-507, September 2000.

[6] M. Dendrinos, S. Bakamidis, and G. Carayannis, “Speech enhancement from noise: a regenerative approach,” Speech Communication, Vol. 10, pp. 45-57, February 1991.

[7] S. Doclo and M. Moonen, “SVD-based optimal filtering with applications to noise reduction in speech signals,” IEEE Workshop on App., Sig., Proc., to Audio, Acoust., pp. 143-146, New Paltz, N.Y., USA, October 1999, also in internal report, K. U. Leuven, April 1999.

[8] Y. Ephraim and H. L. V. Trees, “A signal subspace approach for speech enhancement,” IEEE Trans. Speech, Audio Proc., Vol. 3, No. 4, pp. 251-266, July 1995.

[9] P. S. K. Hansen, “Signal subspace methods for speech enhancement,” Ph.D. Thesis, Technical Univ. of Denmark, Lyngby, Denmark, September 1997.

[10] S. H. Jensen, P. C. Hansen, S. D. Hansen, and J. A. Sorensen, “Reduction of broad-band noise in speech by truncated QSVD,” IEEE Trans. Speech, Audio Proc., Vol. 3, pp. 439-448, November 1995.

[11] A. Cichocki, R. R. Gharieb, and T. Hoya, “Efficient extraction of evoked potentials by combination of Wiener filtering and subspace methods,” in Proc. ICASSP-2001, Salt Lake City, May 2001.

[12] P. K. Sadasivan and D. N. Dutt, “SVD based technique for noise reduction in electroencephalographic signals,” Signal Processing, Vol. 55, No.2, pp. 179-189, 1996.

[13] S. Haykin, “Unsupervised adaptive filtering,” Volume I & II, John Wiley & Sons, Inc, 2000.

[14] S. Amari and A. Cichocki, “Adaptive blind signal processing—neural network approaches,” Proc. IEEE, Vol. 86, No. 10, pp. 2026-2048, October 1998.

[15] K. Torkkola, “Blind separation of delayed sources based on information maximization,” Proc.ICASSP-96, pp. 3509-3512, 1996.

[16] H. L. Nguyen Thi and C. Jutten, “Blind source separation for convolved mixtures,” Signal Processing, Vol. 45, No. 2, pp. 209-229, 1995.

[17] C. Jutten and J. Herault, “Blind separation of sources, part I: an adaptive algorithm based on neuromimetic architecture,” Signal Processing, Vol. 24, No. 1, pp. 1-10, 1991.

[18] J. R. Deller, Jr., J. G. Proakis, and J. H. L. Hansen, “Discrete-time processing of speech signals,” Macmillan Publishing Company, 1993.

[19] R. Le Bouquin-Jennes, A. Akbari Azirani, and G. Faucon, “Enhancement of Speech Degraded by Coherent and Incoherent Noise Using a Cross-Spectral Estimator,” IEEE Trans. on Speech, Audio Proc., Vol. 5, No. 5, pp. 484-487, September 1997.

[20] S. Haykin, “Adaptive Filter Theory,” 2nd Ed., Englewood Cliffs, N.J.: Prentice-Hall, 1991.

[21] T. Murakami, M. Namba, T. Hoya, and Y. Ishida, “Speech Enhancement Using MUSIC (MUltiple SIgnal Classification) Algorithm,” Proc. IASTED 2001, pp. 213-216, Rhodes, Greece, July 2001.

What is claimed is:

1. A noise removing system comprising:
an input part including a plurality of channels for inputting a plurality of observed signals;
a noise removing part that removes noises from the plurality of observed signals inputted via the plurality of channels of the input part; and
an output part including a plurality of channels for outputting a plurality of noise-removed signals whose noises have been removed by the noise removing part,
wherein the noise removing part includes singular value decomposition units of plural stages which are cascaded to one another for processing the plurality of observed signals inputted via the plurality of channels of the input part; and the singular value decomposition unit of each stage separates a plurality of input signals corresponding to the respective channels into a signal subspace and a noise subspace by a singular value decomposition, and extracts a plurality of output signals, which are signals over a time region, by conducting orthonormal projection of the plurality of input signals onto the separated signal subspace.

2. A noise removing system according to claim 1, wherein the noise removing part further includes a delay element or an advancer that shifts from each other at least two output signals, which belong to different channels of the plurality of output signals outputted from the singular value decomposition unit of each stage, by a predetermined number of samples.

3. A noise removing system according to claim 1, further comprising an amplitude adjusting part that increases or decreases amplitudes of the plurality of noise-removed signals outputted from the output part.

4. A noise removing method comprising:
a step of inputting a plurality of observed signals;
a noise removing step of removing noises from the plurality of observed signals; and
a step of outputting a plurality of noise-removed signals whose noises have been removed,
wherein, in the noise removing step, the noises are removed from the plurality of observed signals by applying a singular value decomposition to the plurality of observed signals plural times; and the singular value decomposition of each time separates a plurality of input signals corresponding to the plurality of observed signals into a signal subspace and a noise subspace by a singular value decomposition, and extracts a plurality of output signals, which are signals over a time region, by conducting orthonormal projection of the plurality of input signals onto the separated signal subspace.

5. A noise removing system comprising:
an input part including a plurality of channels for inputting a plurality of observed signals;
a signal pre-processing part that performs a signal pre-processing so as to remove noises from the plurality of observed signals inputted via the plurality of channels of the input part;
an adaptive signal enhancer that performs an adaptive filtering processing so as to enhance a plurality of signals outputted from the signal pre-processing part; and
an output part including a plurality of channels for outputting a plurality of signals outputted from the adaptive signal enhancer.

6. A noise removing system according to claim 5, wherein the signal pre-processing part includes a singular value decomposition unit that separates each of the observed signals inputted via the plurality of channels of the input part into a signal subspace and a noise subspace by a singular value deposition, and extracts a plurality of output signals, which are signals over a time region, by conducting orthonormal projection of the plurality of observed signals onto the separated signal subspace.

7. A noise removing system according to claim 5, wherein the signal pre-processing part includes singular value decomposition units of plural stages which are cascaded to one another for processing the plurality of observed signals inputted via the plurality of channels of the input part; and the singular value decomposition unit of each stage separates a plurality of input signals corresponding to the respective channels into a signal subspace and a noise subspace by a singular value decomposition, and extracts a plurality of output signals, which are signals over a time region, by conducting orthonormal projection of the plurality of input signals onto the separated signal subspace.

8. A noise removing system according to claim 7, wherein the signal pre-processing part further includes a delay element or an advancer that shifts from each other at least two output signals, which belong to different channels of the plurality of output signals outputted from the singular value decomposition unit of each stage, by a predetermined number of samples.

9. A noise removing system according to claim 7, wherein the signal pre-processing part further includes an amplitude adjusting part that increases or decreases amplitudes of the plurality of output signals outputted from the singular value decomposition unit of a final stage among the singular value decomposition units of the plural stages.

10. A noise removing system according to claim 5, wherein the adaptive signal enhancer includes an adaptive filter that performs an adaptive filtering processing on a plurality of signals outputted from the signal pre-processing part.

11. A noise removing system according to claim 10, wherein the adaptive signal enhancer further includes a delay element that delays the plurality of signals, which are outputted from the signal pre-processing part and inputted into the adaptive filter, by a predetermined number of samples.

12. A noise removing system according to claim 5, wherein the adaptive signal enhancer is connected to the signal pre-processing part in series.

13. A noise removing system according to claim 5, wherein the adaptive signal enhancer is connected to the signal pre-processing part in parallel.

14. A noise removing method comprising:
a step of inputting a plurality of observed signals;
a signal pre-processing step of performing a signal pre-processing so as to remove noises from the plurality of observed signals;
a step of performing an adaptive filtering processing so as to enhance a plurality of signals which have been subjected to the signal pre-processing; and
a step of outputting a plurality of signals which have been subjected to the adaptive filtering processing.

15. A noise removing method according to claim 14, wherein, in the signal pre-processing step, a plurality of output signals, which are signals over a time region, are extracted by separating the respective of observed signals into a signal subspace and a noise subspace by a singular value decomposition, and orthonormally projecting the plurality of observed signals onto the separated signal subspace.

16. A noise removing method according to claim 14, wherein, in the signal pre-processing step, noises are removed from the plurality of observed signals by applying a singular value decomposition to the plurality of observed signals plural times; and the singular value decomposition of each time extracts a plurality of output signals, which are signals over a time region, by separating a plurality of input signals corresponding to the plurality of observed signals into a signal subspace and a noise subspace by a singular value decomposition, and orthonormally projecting the plurality of input signals onto the separated signal subspace.
